(19) United States
(12) Patent Application Publication
(10) Pub. No.: US 2006/0078739 A1
(43) Pub. Date: Apr. 13, 2006

(54) Methods for improving barrier of a coated substrate

(76) Inventor: William A. Essary, Saxonburg, PA (US)

Correspondence Address: PPG INDUSTRIES, INC.;Intellectual Property Department, One PPG Place, Pittsburgh, PA, 15272, US

(21) Appl. No.: 10/960,321

(22) Filed: Oct. 7, 2004

(51) Int. Cl. B05D 1/40; B32B 9/04; B32B 27/36

(52) U.S. Cl. 428/411.1; 427/331; 428/413; 428/480

(57) ABSTRACT

Methods for improving the barrier of a substrate having a barrier coating are disclosed. The methods generally comprise contacting the barrier coated substrate with an acid. Substrates treated according to this method are also disclosed.

### FIELD OF THE INVENTION

The present invention is generally directed to methods for improving the barrier of a substrate coated with a barrier coating comprising contacting the coated substrate with an acid.

### BACKGROUND INFORMATION

Plastics have found increasing use as replacements for glass and metal containers in packaging. Advantages of plastic packaging over glass packaging include lighter weight, decreased breakage and potentially lower costs. An advantage of plastic packaging over metal packaging is that plastic can more easily be designed as re-closable. Shortcomings in the gas barrier properties of common plastic packaging materials (e.g., polyesters, polyolefins and polycarbonates) can be a problem when such materials are used to package oxygen-sensitive items and/or carbonated beverages. For example, some oxygen-sensitive products may become discolored and/or spoiled upon even minute exposures to oxygen, and carbonated beverages can lose their carbonation or become “flat” if carbon dioxide is allowed to egress.

Specifically, gases such as oxygen and carbon dioxide can readily permeate through most of the plastic materials commonly used by the packaging industry. The oxygen permeability constant (“P(O₂)”) quantifies the amount of oxygen that can pass through a film or coating under a specific set of circumstances and is generally expressed in units of cm³-mil/100 inches²/atmosphere/day. This is a standard unit of permeation measured as cubic centimeters of oxygen permeating through 1 mil (25.4 micron) thickness of a sample, 100 square inches (645 square centimeters) in an area, over a 24-hour period, under a partial pressure differential of one atmosphere at specific temperature and relative humidity (R.H.) conditions. As used herein, P(O₂) values are reported at 23° C.±5° C. and an R.H. of 50 percent unless otherwise stated.

One of the common packing materials used today by the food and beverage industry is poly(ethylene terephthalate) (“PET”). Notwithstanding its widespread use, PET has a relatively high P(O₂) value (i.e., about 6.0). Other packaging materials such as polyesters, polyolefins, polycarbonates and the like are similarly gas permeable. The food and beverage packaging industry has sought ways to improve the P(O₂) value of such packaging materials.

### SUMMARY OF THE INVENTION

The present invention is directed to methods for improving the barrier of a substrate having a barrier coating on at least a portion of the substrate, comprising contacting the barrier coated substrate with an acid. The barrier coating does not contain inorganic oxide or silica. Substrates treated according to these methods are also within the scope of the present invention.

### DETAILED DESCRIPTION OF THE INVENTION

The present invention is directed to methods for improving the barrier of a substrate having a barrier coating on at least a portion of the substrate comprising contacting the barrier coated substrate with an acid, wherein the barrier coating does not contain an inorganic oxide or silica. Any organic or inorganic acid can be used according to the present invention. In one embodiment, the acid is a monoacid; examples include but are not limited to lactic acid, nitric acid and acetic acid. In another embodiment, a multi-acid is used. “Multi-acid” refers to acids having two or more acid functional groups. Examples include but are not limited to citric acid, phosphoric acid, tartaric acid, itaconic acid, succinic acid, EDTA (ethylenediamine tetracetic acid), ascorbic acid, butanetetracarboxylic acid, tetrahydrofuran tetracarboxylic acid, cyclopentane tetracarboxylic acid, tetracarboxylic acid, and itaconic, citraconic, mesaconic, maleic, fumaric, acrylic, methacrylic, sorbic vinyl phosphonic, vinyl sulfonic and cinnamic acids.

The acid is typically applied to the coated substrate from a water-based or solvent-based solution. The concentration of acid in the solution can be 0.1 weight percent or higher, such as 0.1 weight percent to 25 weight percent, 0.5 to 5 weight percent, or 1.0 weight percent, with weight percent based on the total weight of the solution. A suitable solution can be prepared, for example, by dissolving acid in water. Alternatively, some or all of the water can be replaced with one or more organic solvents. Suitable solvents include lower alcohols, ketones, glycol ethers and the like. A water-based solution will be understood as one having greater than 50 percent water as the solvent and a solvent-based solution as one having less than 50 percent water as the solvent. In certain nonlimiting embodiments of the present invention, the acid solution used in the present methods specifically excludes silane; in other nonlimiting embodiments, the acid in the acid solution is from a nonpolymeric acid.

As noted above, the substrates treated according to the present methods are already coated with a barrier coating. As used herein, the term “barrier coating” refers to any coating having a low permeability to gases such as oxygen and/or carbon dioxide; that is, the coating exhibits resistance to the passage of oxygen, carbon dioxide and/or other gases through the material. Any resistance to the permeation of any gas is sufficient to qualify the coating as a “barrier coating” according to the present invention; certain applications may need a relatively high resistance to either carbon dioxide or oxygen, but not both, and certain applications may need only a relatively low resistance to carbon dioxide and/or oxygen.

Any suitable barrier coating can be used according to the present invention. In certain nonlimiting embodiments, suitable barrier coatings may be those intended primarily as oxygen barriers exhibiting an oxygen permeability of less than about 3.0, such as less than about 1.0, or less than about 0.5 cm³-mil/100 inches²/atmosphere/day. Barrier coatings according to the present invention that function primarily as carbon dioxide barriers can exhibit a carbon dioxide permeability of less than about 15.0, such as less than about 5.0, or less than 2.0 cm³-mil/100 inches²/atmosphere/day. Suitable barrier coatings can be organic or inorganic; specifically excluded are barrier coatings that contain inorganic oxide or silica. Particularly suitable organic coatings include epoxy amine coatings, such as those described in U.S. Pat. Nos. 5,300,541; 5,006,381; 5,008,137; and 6,309,757, the contents of all of which are hereby incorporated by reference. Epoxy amine barrier coatings are commercially available from PPG Industries, Inc. in their BAIROCADE line of products. In certain nonlimiting embodiments, the barrier coating has amine functionality or residual amine functionality and/or epoxy functionality or residual epoxy functionality. “Epoxy functionality” and “residual epoxy functionality” refer to an epoxy group having a reactive oxygen or the compound formed upon the reaction between such a group and another functional group, respectively. “Amine functionality” and “residual amine functionality” refer to an amine nitrogen with at least one pair of free electrons, including but not limited to those contained in primary, secondary, or tertiary amines. In other nonlimiting embodiments, the barrier coating has basic functionality or residual functionality other than amine functionality or residual amine functionality. “Basic functionality” and “residual basic functionality” refer to basic groups or atoms having at least one pair of free electrons. In other nonlimiting embodiments, other coatings whose barrier can be improved according to the methods of the present invention can be used.

The barrier coating can be applied to the substrate in any manner known in the art, such as dipping, spraying, rolling, brushing, and the like. The barrier coating will typically be at least partially cured prior to treatment according to the present methods. Cure can be effected by an appropriate manner, such as at ambient or elevated temperatures. The barrier coating can have any dry film thickness desired by the user, which will typically be 0.1 to 5.0 mils, such as 0.1 to 1.0 mils.

The substrate coated with a barrier coating can then be treated according to the present methods by contacting the barrier coated substrate with an acid, such as any of the acid solutions described above. It will be appreciated that excessive contact with the acid could cause the barrier coating to wrinkle, swell, and/or otherwise become distorted, removed and/or delaminated from the substrate. Accordingly, the contact time with the acid is less than the time at which the coating begins to swell and/or wrinkle. Typically, this time will be about 20 seconds or less, such as 15 seconds or less. Factors considered in determining contact time include the temperature of the acid, the type of acid and the concentration of the acid. It is surprising that the acid treatment of the present invention results in improved barrier, as it is believed that the acid may actually attack the existing barrier coating, although the inventors do not wish to be bound by this.

In one embodiment, the acid is at or near room temperature, such as 20° C.±5° C. It has been found, however, that enhanced barrier can be obtained when the acid is heated to temperatures greater than room temperature, such as greater than 150° F. (66° C.), ±10° F.; particularly suitable is a temperature of greater than or equal to 180° F. (82° C.), ±10° F., which is the temperature at which heat set poly(ethylene terephthalate) bottles are typically filled.

The contact between the barrier coated substrate and the acid can be by any conventional means, such as by spraying, dipping, rolling, brushing, and the like. Typically, a dip in an acid solution will be suitable.

Following contact with the acid, the substrate is then dried, such as by air drying or forced air dry. The substrate can be rinsed slightly, such as with deionized water.

The acid can further comprise a colorant. As used herein, the term “colorant” refers to a dye, tint or any other substance that can impart color to the acid layer. For example, the acid layer can comprise one or more FDA-approved colorants that are water and/or acidified and/or soluble, which changes the color of the barrier coating, uniformly or nonuniformly.

Any substrate susceptible to gas permeation can be treated according to the present method. As used herein, the term “treated” and like terms refers to contacting the barrier coated substrate with an acid, as described above. Particularly suitable substrates include those that have gas permeability, such as polymers including but not limited to polyesters, polyolefins, polyamides, celluloses, polystyrenes, polyacrylics, polycarbonates, PET, and poly(ethylenenaphthalate) (“PEN”) or any combinations thereof. Following treatment, according to the present method, the substrates will typically have a P(O₂) value or transmission rate lower than the P(O₂) value or transmission rate of the substrates without the treatment. In certain nonlimiting embodiments, the P(O₂) can be lowered by 50 percent, such as by 75 percent or even by 90 percent or greater.

As used herein, unless otherwise expressly specified, all numbers such as those expressing values, ranges, amounts or percentages may be read as if prefaced by the word “about”, even if the term does not expressly appear. Any numerical range recited herein is intended to include all sub-ranges subsumed therein. Plural encompasses singular and vice versa. Also, as used herein, the term “polymer” is meant to refer to prepolymers, oligomers and both homopolymers and copolymers; the prefix “poly” refers to two or more.

### EXAMPLES

The following examples are intended to illustrate the invention, and should not be construed as limiting the invention in any way.

### Example 1

Six, 16 fluid ounce PET bottles were sprayed with BAIROCADE, commercially available from PPG Industries, Inc., following the manufacturer's instructions, cured at 180° F. for 8 minutes, to dry film weight of 300 mg. The coated bottles were immersed for 15 seconds in 1 percent acid solutions heated to 185° F. as indicated in Table 1. Transmission rates in cc/package/day were tested using a Mocon 261.

TABLE 1

| 1% Acid Solution | Transmission |
|---|---|
| citric | .0028 |
| lactic | .0120 |
| acetic | .0169 |
| phosphoric | .0042 |
| tartaric | .0084 |
| nitric | .0160 |

The transmission rate of a BAIROCADE coated PET bottle is typically 0.02÷0.002. The transmission rates of all of the bottles receiving the acid treatment of the present invention were therefor all improved ones.

### Example 2

A plastic bottle, such as a PET bottle, could be coated with an epoxy-amine barrier coating, dipped in a room temperature acid solution for one minute, and an acid solution heated to 185° F. for 15 seconds. The transmission of the room temperature acid treated bottles would be at least 10 percent better (that is, the transmission would be at least 10 percent lower) as compared to the bottle without an acid treatment, and the transmission of the heated acid treated bottles would be at least 70 percent better (that is, the transmission would be least 70 percent lower) as compared to the bottle without an acid treatment.

Whereas particular embodiments of this invention have been described above for purposes of illustration, it will be evident to those skilled in the art that numerous variations of the details of the present invention may be made without departing from the invention as defined in the appended claims.

What is claimed is:

1. A method for improving the barrier of a substrate having a barrier coating on at least a portion of the substrate comprising contacting the barrier coated substrate with an acid, wherein the barrier coating does not contain inorganic oxide or silica.

2. The method of claim 1, wherein the acid is a monoacid.

3. The method of claim 1, wherein the acid is a multi-acid.

4. The method of claim 3, wherein the acid is citric acid.

5. The method of claim 1, wherein the acid is in solution.

6. The method of claim 5, wherein the solution is water-based.

7. The method of claim 5, wherein the solution is solvent-based.

8. The method of claim 5, wherein the concentration of acid in the solution is at least 0.1 weight percent.

9. The method of claim 5, wherein the concentration of acid in the solution is 0.5 to 5.0 weight percent.

10. The method of claim 1, wherein the contact time is less than the time at which the barrier coating begins to swell and/or wrinkle.

11. The method of claim 10, wherein the contact time is 20 seconds or less.

12. The method of claim 10, wherein the contact time is 15 seconds or less.

13. The method of claim 1, wherein the acid is at a temperature greater than room temperature during the contacting step.

14. The method of claim 13, wherein the acid is at a temperature of greater than or equal to 150° F.

15. The method of claim 5, wherein the solution further comprises one or more colorants.

16. The method of claim 1, wherein the barrier coating is organic.

17. The method of claim 16, wherein the barrier coating comprises epoxy and/or amine functionality and/or residual epoxy and/or residual amine functionality.

18. A substrate treated according to the method of claim 1.

19. The substrate of claim 18, wherein the substrate comprises PET.

20. The substrate of claim 19, wherein the P(O₂) of the treated substrate is at least 50 percent less than the P(O₂) of an untreated substrate.

21. The substrate of claim 20, wherein the P(O₂) of the treated substrate is at least 75 percent less than the P(O₂) of an untreated substrate.

22. A method for improving the barrier of a substrate coated with a barrier coating comprising amine functionality, comprising contacting the barrier coated substrate with an acid.

23. The method of claim 22, wherein the barrier coating further comprises epoxy groups or residues thereof.

24. The method of claim 22, wherein the P(O₂) of the treated substrate is at least 75 percent lower than an untreated substrate.

25. The method of claim 22, wherein the P(O₂) of the treated substrate is at least 90 percent lower than an untreated substrate.

26. The method of claim 1, wherein the P(O₂) of the treated substrate is at least 75 percent lower than an untreated substrate.

27. The method of claim 1, wherein the P(O₂) of the treated substrate is at least 90 percent lower than an untreated substrate.
